(19) United States
(12) Patent Application Publication
(10) Pub. No.: US 2008/0285762 A1
(43) Pub. Date: Nov. 20, 2008

(54) POINT SOURCE SPEAKER SYSTEMS

(76) Inventors: Keiichi Iwamoto, Saratoga, CA (US); Gregory Scott Rice, San Jose, CA (US)

Correspondence Address: KANG LIM, 3494 CAMINO TASSAJARA ROAD #436, DANVILLE, CA, 94506, US

(21) Appl. No.: 11/749,080

(22) Filed: May 15, 2007

(51) Int. Cl. H04R 5/00

(52) U.S. Cl. 381/17

(57) ABSTRACT

Point source speaker systems are provided. The point source speaker system receives audio input from a device. The system comprises a mountable enclosure, which contains a speaker array. The array includes a substantially forward facing left speaker, a substantially forward facing center speaker, a substantially forward facing right speaker and a horizontally mounted woofer speaker. A woofer tunnel is located behind the left, center and right speakers. The woofer tunnel accelerates woofer sound waves and terminuses at a woofer baffle which leads to a woofer port. The left speaker, center speaker and right speaker may include more than one speaker. One or more of these left speakers and right speakers may be a tweeter. The left speakers receive a left minus right input, the center speakers receive a right plus left input, and the right speakers receive right minus left input.

### BACKGROUND OF THE INVENTION

This invention relates generally to a point source speaker system and more particularly the application of the principles of wave interferometry to the reproduction of stereophonic sound via a point source speaker enclosure.

Traditionally, audiophiles have focused on the use of two or more speaker systems. Usually, arranged with one speaker to the left of center, another to the right, and a non-directional subwoofer for low band sounds. With the increasing popularity of home entertainment systems and surround sound, additional speakers are added to the system in an attempt to surround the listener with sound for a more life-like experience.

These traditional systems suffer from a number of defects. Most obviously, these systems are cumbersome and require a large amount of space. Some systems utilize six or more speakers, which may be placed in a particular arrangement within the listener's room. Additionally, speakers may be placed in appropriate locations in order to avoid undesirable effects on the sound quality. For example, placing speakers too close to a corner in a room produces reflections which undesirably alter to sound propagation pattern of the speaker.

The best arrangement of speakers in a room is to position the listener and the speakers in an arrangement that forms an isosceles right triangle with the angle at the vertice of the listener being 90° and the speakers being at the vertices along the base of the triangle. In practice, the distance between the speakers and the listener may vary as long as the angle at the vertice of the listener is maintained at 90°.

Even in this ideal set-up, significant problems arise that negatively impact the listener's experience. Each speaker emits a Separate acoustic wave. According to the principles of wave theory, the separate waves will interact within the space-time domain to form a resultant wave form that is dependant on the phase of the original waves at particular points in the space-time domain. The interaction will be constructive in the areas of phase alignment creating an increased signal or bright spot. At points where the phase between the two original waves is 180° out of phase the interaction is destructive creating null or dead spots.

This wave interference phenomenon is akin to the effects created by a light interferometer which demonstrates the wave properties of light. A light beam is split by transmitting the light from a single source through two or more slits. The light output from the slits forms a series of bright rings where the light from each slit is in phase and dark rings where the light from each slit is out of phase.

As a result of this phenomenon, as applied to acoustic waves from traditional stereo speakers, the position of the listener in the acoustic wave interference pattern determines the quality of the sound heard by the listener. Thus, if the listener is positioned at a point where the acoustic waves from the speakers are out of phase, the listener will perceive the area as a dead spot.

Additionally, the phenomenon results in what has been coined by some in the audio industry as a “comb filter effect”. This term is borrowed from the field of electronics to describe a particular type of filter in which the filter throughput diagram is shaped like a comb. If a listener moves their head back and forth while listening to conventional speakers, their ears wilt pass through alternately pass through bright spots and dead spots (i.e., areas where the acoustic waves are in phase and out of phase, respectively). As a result the sound heard by the listener fades in and out as the listener's head moves.

Additionally, the standard two or three speaker (the third being a subwoofer) speaker arrangement also suffers the additional defect of having a weak center channel. This is partially remedied in surround sound speaker set-ups by adding a center speaker, but this utilizes additional space in the room and increases the cost of the system.

### SUMMARY OF THE INVENTION

To achieve the foregoing and in accordance with the present invention, systems for a point source speakers are provided. In accordance with the illustrated embodiments, the present invention provides a novel, cost effective point source speaker system. In particular, the present invention eliminates cost, space and comb effect defects associated with a traditional speaker system through the use of a point source speaker enclosure and interferometric processing of the L and R stereo signals.

The point source speaker system receives audio input from a device such as DVD player, receiver or television. The point source speaker system comprises an enclosure, which contains a speaker array. The enclosure is mountable. The speaker array may include a substantially forward facing left speaker, a substantially forward facing center speaker, a substantially forward facing right speaker and a horizontally mounted woofer speaker.

A woofer tunnel is located behind the left speaker, center speaker and right speaker. The woofer tunnel may be rectangular or cylindrical. The woofer tunnel accelerates woofer sound waves and couples to a woofer port which leads to the exterior of the enclosure.

The woofer port is a conical tube, and exits the enclosure from a woofer port opening. The opening may be located on the front, side top or bottom of the enclosure.

The left speaker, center speaker and right speaker may include more than one speaker. One or more of these left speakers and right speakers may be a tweeter.

The left speakers receive a left minus right input, the center speakers receive a right plus left input, and the right speakers receive right minus left input.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

FIG. 1 shows a block diagram of a top plan view of the point source speaker enclosure in accordance with an embodiments of the present invention;

FIG. 2 shows a block diagram of the input signal processor for the point source speaker system of FIG. 1;

FIG. 3 shows a schematic diagram of the sonic image differential processor for the point source speaker system of FIG. 1;

FIG. 4 shows an illustrative diagram demonstrating the interferometric domain for the point source speaker system of FIG. 1;

FIG. 5A shows a schematic diagram of a top plan cross sectional view of the bar point source speaker system in accordance with an embodiment of the present invention;

FIG. 5B shows a schematic diagram of a top plan cross sectional view including sound wave patterns of the bar point source speaker system of FIG. 5A;

FIG. 6 shows a schematic diagram of a front plan view of the bar point source speaker system of FIG. 5A;

FIG. 7 shows a schematic diagram of a rear plan view of the bar point source speaker system of FIG. 5A;

FIG. 8 shows a schematic diagram of a top plan view of the bar point source speaker system of FIG. 5A;

FIG. 9A shows a block diagram of a top plan view of the bar point source speaker system of FIG. 5A;

FIG. 9B shows an alternate second block diagram of a top plan view of the bar point source speaker system of FIG. 5A;

FIG. 9C shows an alternate third block diagram of a top plan view of the bar point source speaker system of FIG. 5A;

FIG. 10 shows an exploded diagram of a docking point source speaker system in accordance with an embodiment of the present invention;

FIG. 11 shows an assembled schematic diagram of a docking point source speaker system of FIG. 10;

FIG. 12 shows an illustration of a tower point source speaker system in accordance with an embodiment of the present invention;

FIG. 13 shows an exploded diagram of the tower point source speaker system of FIG. 12;

FIG. 14 shows an illustration of a short bar point source speaker system in accordance with an embodiment of the present invention;

FIG. 15 shows a top cross sectional diagram of the short bar point source speaker system of FIG. 14; and

FIG. 16 shows an illustration of a radio point source speaker system in accordance with an embodiment of the present invention.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

The present invention makes use of the principles of wave interferometry to provide stereophonic sound from a point source speaker enclosure. As defined herein, wave interferometry is the principle of the effect that multiple waves such as light, or this case, acoustic interfere with each other in a manner that may be complementary or destructive.

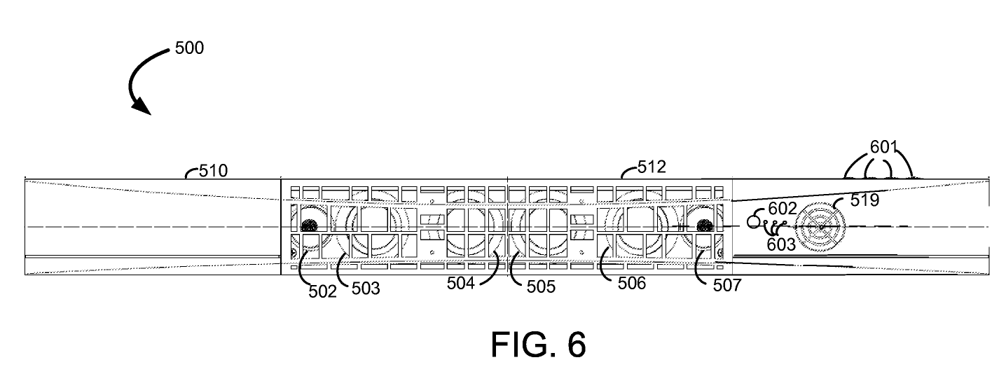

Some embodiments make use of wave interferometry principles by utilizing a point source speaker with three speakers, namely a left, right and center speaker. Stereophonic signals comprise two channels, left (L) and right (R). Throughout this specification and drawings the abbreviations L and R will be used to refer to the left and right stereo signals, respectively. In the some embodiments, the left speaker receives as an input signal L−R (that is the left stereo signal minus the right signal); the right speaker receives as an input signal R−L (that is the right stereo signal minus the left stereo signal); and the center speaker receives as an input signal R+L (that is the right signal plus the left signal). The interferometric properties of the acoustic waves produced by the pont source is discussed below in detail with respect to FIG. 6. Next the overall structure of the some embodiments is discussed.

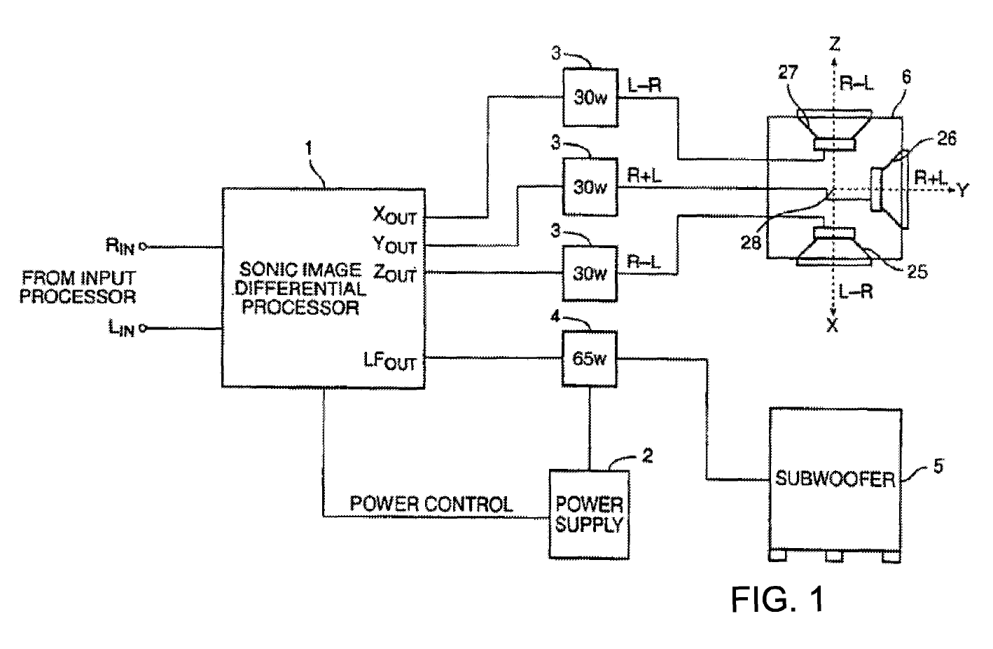

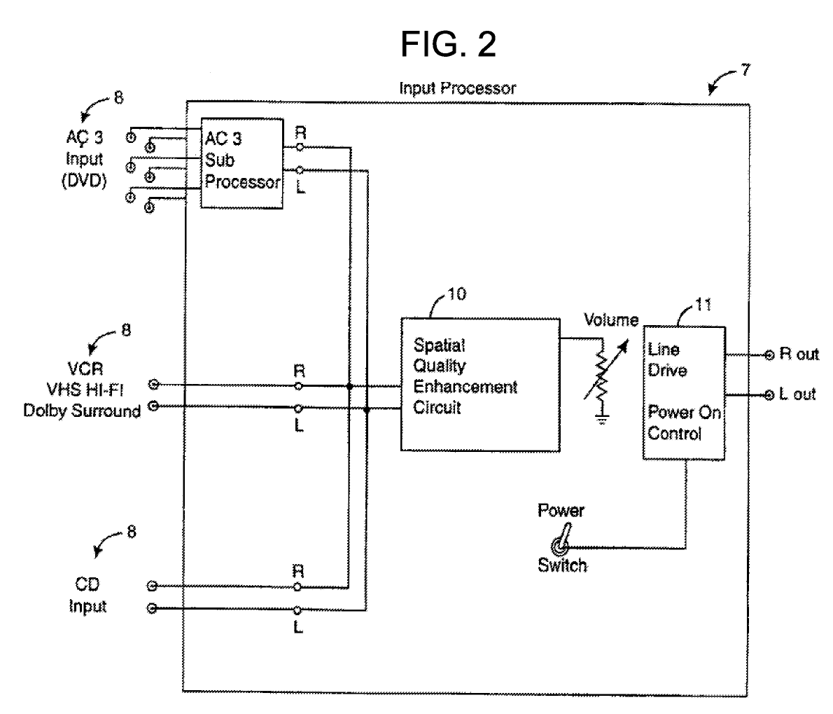

The major components of some embodiments are shown in FIG. 1. These components include sonic image differential processor 1, power supply 2, three 30 watt amplifiers 3, one 65 watt subwoofer amplifier 4, subwoofer 5, and point source speaker enclosure 6. Some image processor 1 receives left and right stereo input signals (L and R) from input process 7. The structure and function of input processor 7 is discussed below with respect to FIG. 2.

As depicted in FIG. 1, sonic image differential processor 1 has two inputs for the L and R signals from input processor 6, and four outputs to amplifiers 3 and 4. The output signal from each of amplifiers 3 is input to one of the three speakers in point source speaker enclosure 6. Point source speaker enclosure 6 contains three speakers in a tri-axial (X,Y,Z axes) arrangement to form a tri-axial interferometric transducer array. The output signal from subwoofer amplifier 4 is input to subwoofer 5. Power is provided by power supply 2.

In operation, sonic image differential processor 1 processes the L and R signals within the interferometric frequency range in accordance with the interferometric properties of the some embodiments. In particular, L and R signals are processed into three channels, one for each of the three axes (X, Y, Z) of point source speaker enclosure 6, and output to amplifiers 3 via outputs Xout, Yout and Zout as L−R, R+L and R−L, respectively. The L−R, R+L and R−L signals are then amplified by amplifiers 3 and input to the X, Y and Z (left, center and right) speakers, respectively, in point source speaker 6. L and R signals below the interferometric range are output from Sonic image differential processor 1 via line feed (LE out), then amplified by subwoofer amplifier 4 and input to subwoofer 5.

The function of: input processor 7 is to simply re-process the signals from a given acoustic source 8 (such as a DVD, VCR or CD) for input to sonic image differential processor 1 and the structure may take many forms. In the some embodiments as shown in FIG. 2, input processor 7 includes AC 3 subprocessor 9 for an AC3 input (DVD), spatial quality enhancement circuit 10, line drive/power-on control circuit 11. Spatial quality enhancement circuit 10 may be any type of signal enhancement such as Dolby 4-2-4.

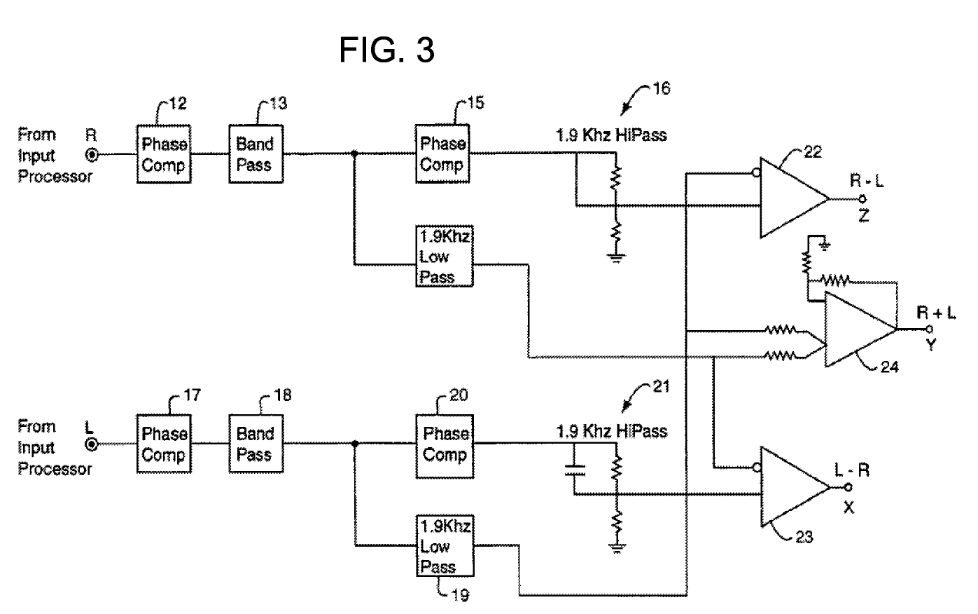

Sonic image differential processor 1 is depicted in detail in FIG. 3. As shown, the L and R signals are input to sonic image differential processor 1 from input processor 7 and processed in parallel by identical circuitry. Accordingly, the circuitry is discussed in detail only with respect to one of the channels.

Signal R is first processed by Fourier phase compensation circuit 12. Next the signal is filtered by third order band pass filter 13 with a low cut-off at 136 Hz and a high cut-off at 35 KHZ. The frequencies in the L and R signals below 136 Hz are produced by subwoofer 5 only. The output from band pass filter 13 is then passed to third order low pass filter 14 with a cut-off of 1.9 KHz, which defines the high end of the frequency band which is interferometricly processed (i.e., processed into the L−R, R+L and R−L signals). This band is referred o herein as the interferometric frequency band. The low end cut-off of band pass filter defines the low end of the interferometric frequency band or interferometric domain.

Note, that the ideal interferometric frequency band is dependent on the size and proximity of the speakers in point source speaker enclosure 6. The values for the interferometric frequency band utilized in the some embodiments are chosen in accordance with the particular speaker size and distance of the speaker in point source speaker enclosure as depicted in FIG. 1.

The output from band pass filter 13 is also processed by a phase delay compensator 15 to compensate for the delay in low pass filter 14. The output from phase delay compensator is then processed by shelving filter 16 (i.e., high pass filter) which increases the gain on the signal above 1.9 KHz. The frequency shelf of shelving filter 16 is chosen to match the frequency of low pass filter 14. Thus, shelving filter 16 serves to increase the gain on signal R above the interferometric frequency band. This boost of the signal above 1.9 KHz since the R and L signals above the interferometric frequency band are not produced by the center speaker in point source speaker enclosure 6. Thus, only frequencies within the interferometric domain are produced by all three speakers in point source speaker enclosure 6.

The output from shelving filter 16 (R signal) and the inverted output from low pass filter 19 (−L signal) are input to operational amplifier (op amp) 22. This results in signal R−L from op amp 22. Likewise in some embodiments, the output from shelving filter 21 (L signal) and the inverted output from low pass filter 14 (−R signal) are input to op amp 22. This results in signal L-R from op amp 23. Additionally, the output from low pass filter 14 (R signal) and the output from low pass filter 19 (L signal) are input to op amp 24. This results in signal R+L for the interferometric frequency band only.

In the some embodiments, sonic image differential processor 1 is comprised of analog circuitry. However, one of ordinary skill could readily implement the identical functionality using digital circuitry such as a DSP (digital signal processor).

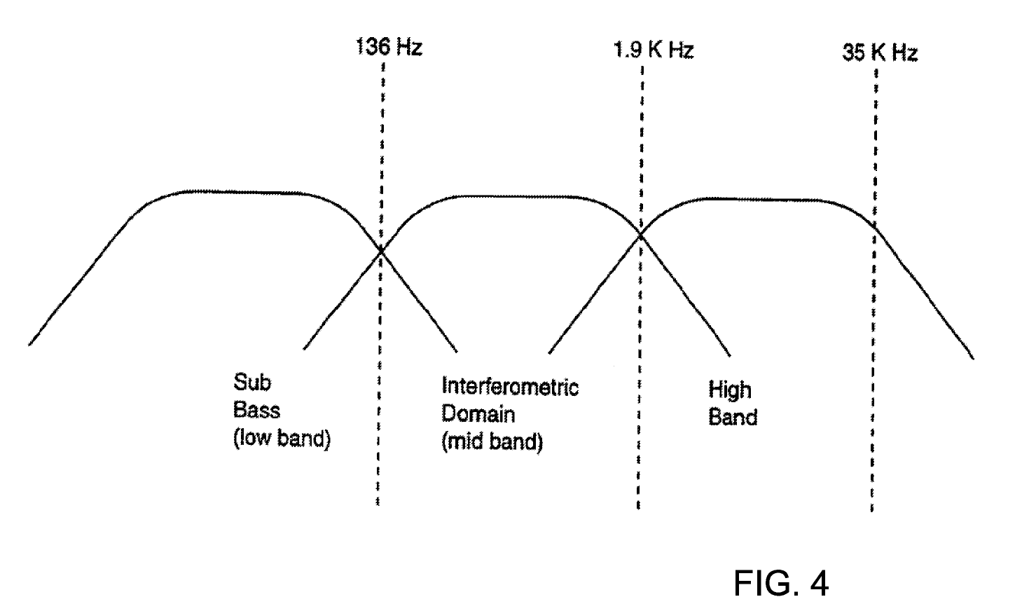

The frequency processing bands of the some embodiments are depicted in FIG. 4. The sub bass or low band domain is below 136 Hz. The interferometric frequency band or mid band domain is between 136 Hz and 1.9 KHz. The high band domain is between 1.9 KHz and 35 KHz. As previously discussed the most effective values are dependent on the size and distance of the speakers in point source speaker enclosure 6.

Point source speaker enclosure 6 is depicted in detail in FIG. 1 and is configured as a box to house speakers 25, 26 and 27. The walls of point source speaker enclosure 6 are formed of a sturdy material such as wood in order to arrange speakers 25, 26 and 27 as close together as possible. A sturdy material is required since the magnets contained in each of speakers 25, 26 and 27 will create a force pushing speakers 25, 26 and 27 apart. The closer speakers 25, 26 and 27 are together, the higher the high end of the interferometric domain. This is advantageous in that it enables use of the interferometric properties of the present invention over a greater frequency range.

Generally, the smaller the speaker the smaller the distance between speakers 25, 26 and 27 and the wider the interferometric domain. In some embodiments, three 3″ speakers and a subwoofer are employed.

Alternate configurations are also possible. For example, speakers, 25, 26 and 27 may be 4½″ speakers without a subwoofer. A combination point source speaker enclosure housing six speakers is also possible. Such a system would include three smaller speakers such as 3″ speakers for the upper end of the interferometric domain and three larger speakers such as 4½″ speakers for the lower end of the interferometric domain.

Speakers 25 (left), 26 (center) and 27 (right) are triaxially housed one each in point source speaker enclosure 6 along the X (left), Y (center) and Z (right) axes, respectively. That is, left and right speakers 25 and 27 are each arranged along an axis 90° from the axis of center speaker 26. Further, left and right speakers 25 and 27 are arranged along axes 180° from each other, i.e., in opposing directions. The effect of arranging speakers 25, 26 and 27 in such a manner is to have the acoustic wave from each of speakers 25, 26 and 27 emanating from a single point of origin 28, hence a point source.

The most expedient shape for point source speaker enclosure 6 is a cube having all six panels of equal size. However, alternate sizes and shapes are possible. In order to provide the best results, speakers 25, 26 and 27 should be placed as close together as possible and the axis of each speaker should intersect at a common point of origin 28.

In one embodiment, point source speaker enclosure 6 is 5¼″ wide, 5½″ tall and 4¼″ deep. The shorter depth allows Placement of point source speaker enclosure 6 on top of a particular model of a Sharp® flat panel television.

Additionally, point source speaker enclosure may be filled with fiber glass to absorb all of the high frequency (HF) backwaves from speakers 25, 26 and 21.

Speakers 25, 26 and 27 are coupled to sonic image differential processor 1 such that left speaker 25 is coupled to op amp 23, center speaker 26 is coupled to op amp 24 and right speaker 27 is coupled to op amp 21. As a result, signal L−R is emitted from left speaker 25, signal R+L is emitted from center speaker 26 and signal R−L is emitted from right speaker 27.

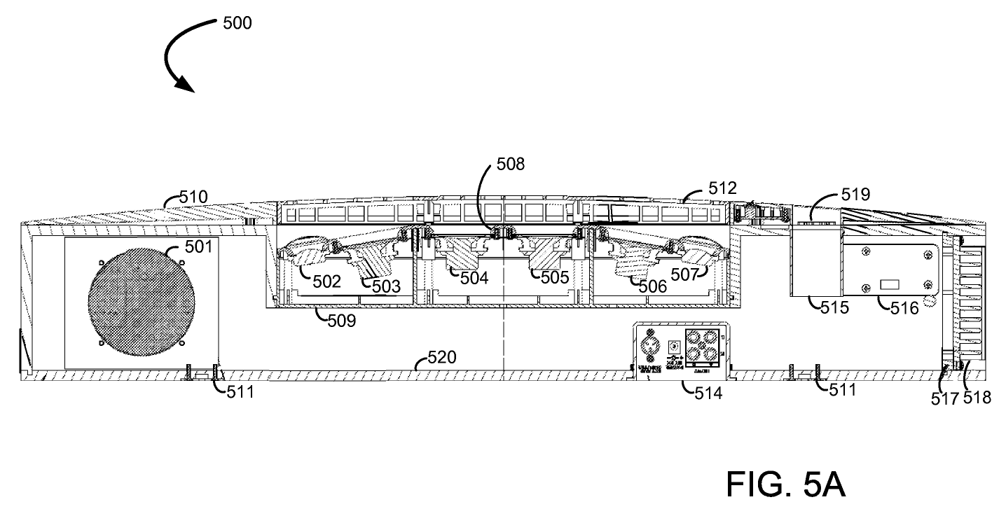

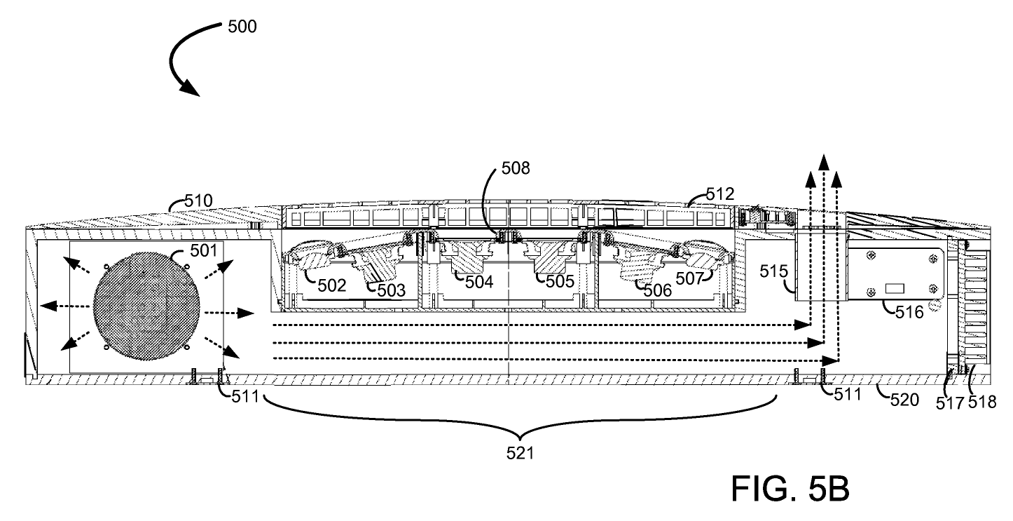

In another embodiment as shown in FIGS. 5 to 8. For many customers, the speaker system employed may provide not only superior audio but may appear attractive for use with flat paneled televisions. For the audiophile, a sound system is a functional sculpture. As such, speaker dimensions and geometry may be further constrained by aesthetics as well as functionality.

In the embodiments shown in FIGS. 5 to 8, a bar style point source speaker system is provided. Bar geometry enables the point source speaker system to be mounted in a functionally optimal and aesthetically appealing location when utilized with a thin paneled display, such as plasma or Liquid Crystal Display (LCD) televisions.

Such displays are often wall mounted, thereby eliminating stands or furniture required to hold the display. This removal of unnecessary furniture also eliminates much of the surface area typically occurring at a media-entertainment location. Traditional speaker systems may be unable to be placed appropriately due to the lack of surfaces to place them upon. The present bar point source speaker system is configured to be mountable on the wall; providing a sleek and functional sound system for modern flat screen Televisions, or low profile locations.

Additionally, in some embodiments, the bar point source speaker system disclosed may be incorporated into a flat panel screen television for superior sound built directly into the television. Thus, a complete home theater system may be, conceivably, designed into a single unit. The bar point source speaker system is geometrically configured to be coupled to a flat panel television above or below the picture in order to create a streamlined, sleek and naturally flowing contoured unit.

FIG. 5A shows a schematic diagram of a top plan cross sectional view of the Bar Point Source Speaker System 500 in accordance with an embodiment of the present invention. In some embodiments a Bar Speaker Enclosure 520 may provide structural support for and enclose the components of Bar Point Source Speaker System 500. Bar Speaker Enclosure 520 may, in some embodiments, be composed of wood, since wood has enough rigidity for structural support and natural acoustic properties that makes it a good material for the Bar Speaker Enclosure 520. However, other materials, as is known by those skilled in the art, may be utilized for Bar Speaker Enclosure 520 construction, such as plastics, metals, ceramics or any other appropriate material. In some embodiments, Bar Speaker Enclosure 520 may be 80 mm high, 800 mm long and 105 mm deep. Alternate embodiments may include different dimensions as is desired.

Mounting Brackets 511 may be attached to the rear of Bar Speaker Enclosure 520 in order to facilitate mounting of the Bar Point Source Speaker System 500. In some embodiments two Mounting Brackets 511 may be utilized in order to provide stability of mounting. Mounting Brackets 511 may include metal face plates configured to engage a fastener. In some embodiments other Mounting Brackets 511 may be utilized, as is known by those skilled in the art.

Bar Speaker Enclosure 520 includes seven speakers, a Internal Woofer 501, Left Tweeter 502, Left Main Speaker 503, First Center Speaker 504, Second Center Speaker 505, Right Main Speaker 506 and Right Tweeter 507. Together Left Tweeter 502 and Left Main Speaker 503 represent the line receiving L−R signal. The center channel speakers, First Center Speaker 504 and Second Center Speaker 505, receive L+R signal. Right Main Speaker 506 and Right Tweeter 507 receive R−L signal. In some embodiments, additional speaker numbers, types and arrangements may be utilized in order to effectuate the desired acoustic result.

Left Tweeter 502, Left Main Speaker 503, First Center Speaker 504, Second Center Speaker 505, Right Main Speaker 506 and Right Tweeter 507 may be aligned along a common horizontal plane. Left Tweeter 502, Left Main Speaker 503, First Center Speaker 504, Second Center Speaker 505, Right Main Speaker 506 and Right Tweeter 507 may then face substantially forwards at a 90° angle from the common horizontal plane.

Internal Woofer 501 is located within the Bar Speaker Enclosure 520. Internal Woofer 501 may, in some embodiments, be a 3½″ speaker. Internal Woofer 501 may be mounted horizontally in order to provide a thin profile for the Bar Point Source Speaker System 500. A thin profile for the Bar Point Source Speaker System 500 may be visually appealing and continuous with the visual theme of flat panel displays. Of course Internal Woofer 501 may be mounted in alternate geometries as desired.

Left Tweeter 502 and Right Tweeter 507 may in some embodiments be 1″ speakers capable of providing outputs on the higher end of the audible frequency. Left Main Speaker 503, First Center Speaker 504, Second Center Speaker 505 and Right Main Speaker 506 may, in some embodiments, be 2″ all purpose speakers. Thus Bar Point Source Speaker System 500, in some embodiments, may generate sound waves between 40 Hz to 20 kHz. Alternate speaker sizes may be utilized in some embodiments as is desired. Left Tweeter 502, Left Main Speaker 503, First Center Speaker 504, Second Center Speaker 505, Right Main Speaker 506 and Right Tweeter 507 may be held in place by Speaker Mount 508. Together Speaker Mount 508 and Speaker Enclosure 509 encase the Left Tweeter 502, Left Main Speaker 503, First Center Speaker 504, Second Center Speaker 505, Right Main Speaker 506 and Right Tweeter 507.

In some embodiments, Speaker Mount 508 may be metal, plastic, wood, ceramic or any suitable material as is known by those skilled in the art. Speaker Mount 508 may be rigid as to secure the Left Tweeter 502, Left Main Speaker 503, First Center Speaker 504, Second Center Speaker 505, Right Main Speaker 506 and Right Tweeter 507 in place. Left Tweeter 502, Left Main Speaker 503, First Center Speaker 504, Second Center Speaker 505, Right Main Speaker 506 and Right Tweeter 507 tend to repulse one another due to magnetic forces typically associated with speakers. As such, Speaker Mount 508 may be rigid as to secure the Left Tweeter 502, Left Main Speaker 503, First Center Speaker 504, Second Center Speaker 505, Right Main Speaker 506 and Right Tweeter 507 in place.

In some embodiments, dampeners may be places between Speaker Mount 508 and the speakers as to minimize transfer of vibration created by each of Left Tweeter 502, Left Main Speaker 503, First Center Speaker 504, Second Center Speaker 505, Right Main Speaker 506 and Right Tweeter 507 to one another.

Additionally, in some embodiments the Speaker Mount 508 may be configured as to angle Left Tweeter 502, Left Main Speaker 503, First Center Speaker 504, Second Center Speaker 505, Right Main Speaker 506 and Right Tweeter 507 along specific axis forward from the Bar Point Source Speaker System 500. In some embodiments, Left Tweeter 502, Left Main Speaker 503, First Center Speaker 504, Second Center Speaker 505, Right Main Speaker 506 and Right Tweeter 507 may be placed as close together as possible and the axis of each speaker may intersect at a common point of origin.

Front Panel 510 may cover the front of Bar Speaker Enclosure 520 to enhance aesthetic qualities of Bar Point Source Speaker System 500. Front Panel 510 may be constructed of virtually any material desired as to provide a visual effect. Likewise in some embodiments Speaker Cover 512 may cover the front of Left Tweeter 502, Left Main Speaker 503, First Center Speaker 504, Second Center Speaker 505, Right Main Speaker 506 and Right Tweeter 507 for protective and aesthetic purposes. Speaker Cover 512, in some embodiments, may include a mesh material as to provide minimal hindrance for sound wave propagation. As is known by those skilled in the art, any material with adequate audio properties may be utilized for Speaker Cover 512. Additionally, in some embodiments, a frame may be present to ensure shape of the Speaker Cover 512. Such a frame may be plastic, metal or any suitable material.

Woofer Port 515 leads from the interior of Bar Speaker Enclosure 520 to the exterior through Port Cover 519. Port Cover 519 prevents improper items from inadvertently entering the interior of Bar Speaker Enclosure 520.

Terminals 514 provide input jacks for the Bar Point Source Speaker System 500. Additionally, Terminals 514 may include outputs for external subwoofer components. In some embodiments, Terminals 514 may include RCA jacks and 3.5 mm jacks. However, different or additional inputs and outputs may be included in the Terminals 514 as is desired.

Processor Circuits 516 provides processing of inputs from the Terminals 514 in order to generate output signals for the speakers via Amplifiers 517. Additionally, in some embodiments, an output may be generated for an external subwoofer via Amplifiers 517, which may then be directed to the Terminals 514. Amplifiers 517 include amplification of signals. Processor Circuits 516 and Amplifiers 517 may, in some embodiments, generate heat.

Heat Sink 518 enables temperature stabilization and cooling for Processor Circuits 516 and Amplifiers 517. In some embodiments, Heat Sink 518 may include metal spokes as to increase surface area for passive cooling. In some embodiments, a fan may be utilized in order to actively blow cool air over Heat Sink 518 to increase rates of heat diffusion. Alternate cooling methods may be utilized as is known by those skilled in the art.

FIG. 5B shows a schematic diagram of a top plan cross sectional view, including sound wave patterns, of the Bar Point Source Speaker System 500. The sound waves, illustrated by dotted lines, are presented to illustrate sound propagation from Internal Woofer 501.

Internal Woofer 501 generates Omni-directional sound waves. These waves may propagate down the Woofer Tunnel 521 formed by the interior of Bar Speaker Enclosure 520. In some embodiments, Woofer Tunnel 521 may be rectangular, however additional geometries, such as cylindrical, may be utilized. Woofer Tunnel 521, in some embodiments, is formed by the interior walls of Bar Speaker Enclosure 520 and the Speaker Enclosure 509; however, in some embodiments Woofer Tunnel 521 may be comprised of a separate unit. As earlier stated, in some embodiments Bar Speaker Enclosure 520 may be comprised of wood, or any suitable material. Since Woofer Tunnel 521, in some embodiments, is formed by the interior of Bar Speaker Enclosure 520, it naturally flows that Woofer Tunnel 521 is likewise in some embodiments comprised of wood. However, like Bar Speaker Enclosure 520, additional materials for Woofer Tunnel 521 may be utilized. In some embodiments, Woofer Tunnel 521 may terminate in an open space known as a woofer baffle, may in turn couple to the Woofer Port 515. Thus the woofer baffle may enable sound wave propagation from Woofer Tunnel 521 to the Woofer Port 515 and eventually out of the Enclosure 520.

In some embodiments, Woofer Tunnel 521 may have a ratio of width to length of 1:10 to 1:20, with a preferred ratio of 1:14. However other dimensional ratios may be utilized as is desired. For example, when utilizing a larger speaker for Internal Woofer 501, a smaller ratio of width to length may be utilized, as is known by those skilled in the art. Additionally, the input power to the speaker may also influence the dimensional ratio.

In some embodiments, the sound waves accelerate as they propagate down Woofer Tunnel 521. The sound waves may then be ported through the Woofer Port 515 to the exterior of the Bar Point Source Speaker System 500. In some embodiments, the Woofer Port 515 may be cylindrical, however additional geometries may be utilized as is desired, such as conical or rectangular. Woofer Port 515 may be paper or cardboard, wood, ceramic, metal or any suitable material. In some embodiments, Woofer Port 515 may be located at the end of the Woofer Tunnel 521, opposite the Internal Woofer 501. However, Woofer Port 515 may be located at alternate locations along the Woofer Tunnel 521 as is desired. Additionally, in some embodiments Woofer Port 515 may port directly from the Internal Woofer 501, thereby eliminating the Woofer Tunnel 521. However, such embodiments may adversely affect bass sound quality.

FIG. 6 shows a schematic diagram of a front plan view of the Bar Point Source Speaker System 500. This view clearly illustrates the low profile and sleek design of the Bar Point Source Speaker System 500. Port Cover 519 may be clearly seen in this view. Additionally, Left Tweeter 502, Left Main Speaker 503, First Center Speaker 504, Second Center Speaker 505, Right Main Speaker 506, and Right Tweeter 507 may be seen facing substantially forward from behind the Speaker Cover 512.

Control Switches 601 may be located on the top surface of the Bar Point Source Speaker System 500. In some embodiments, the Control Switches 601 may be located anywhere on the Bar Point Source Speaker System 500. Control Switches 601 may provide manual control of the Bar Point Source Speaker System 500 for tuning, equalizing, and volume control. Additionally, in some embodiments, a remote control may be utilized. Additionally, both Control Switches 601 and a remote control may be utilized.

Sensor 602 may receive signals from a remote control. Sensor 602 may be an infrared sensor; however other sensors types may be utilizes as is known by those skilled in the art. Indicator LEDs 603 may provide indications of power, standby, mode and input.

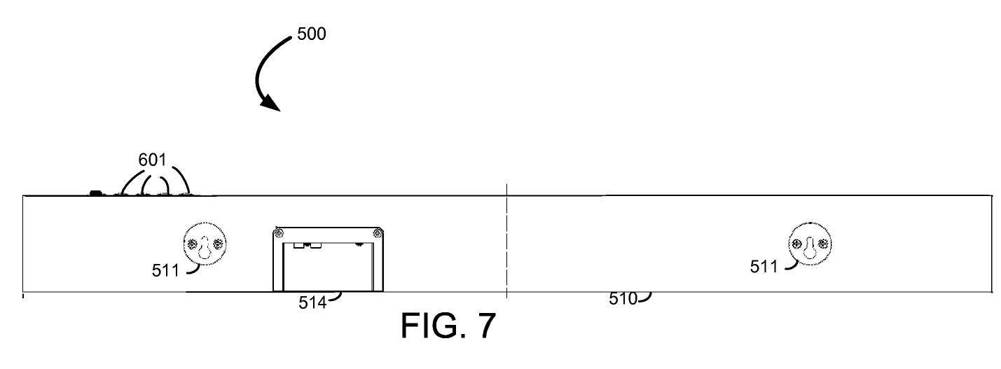

FIG. 7 shows a schematic diagram of a rear plan view of the Bar Point Source Speaker System 500. This diagram clearly illustrates the placement of Mounting Brackets 511 for mounting the Bar Point Source Speaker System 500. Additionally, Terminals 514 may be seen recessed from the exterior of the Bar Point Source Speaker System 500. Insetting Terminals 514 enables input and output connectors to be hidden from frontal viewing, adding to the low profile of the present design.

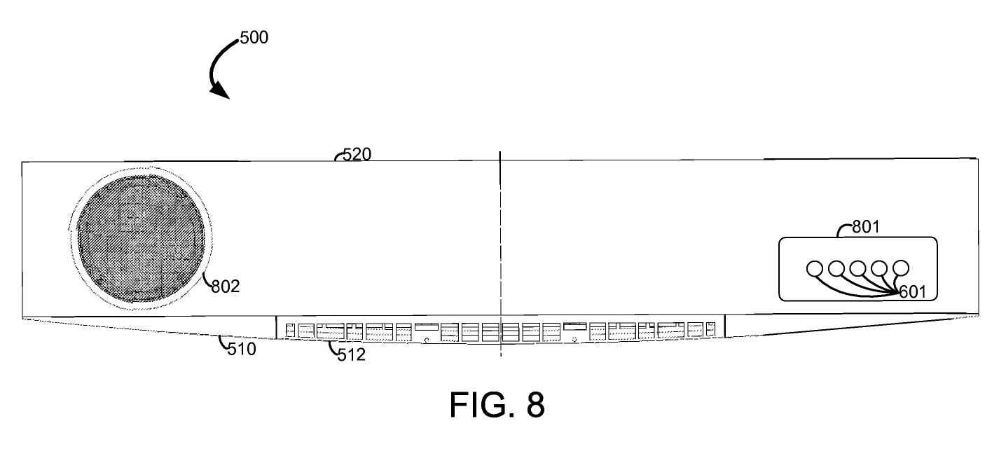

FIG. 8 shows a schematic diagram of a top plan view of the Bar Point Source Speaker System 500. In this view Control Switches 601 is clearly illustrated, located in a Control Panel 801. Control Panel 801 may be plastic in some embodiments. However, any suitable material may be utilized. Woofer Output 802 provides additional output for the Internal Woofer 501. Woofer Output 802, in some embodiments, may include a mesh material as to provide minimal hindrance for sound wave propagation. As is known by those skilled in the art, any material with adequate audio properties may be utilized for Woofer Output 802.

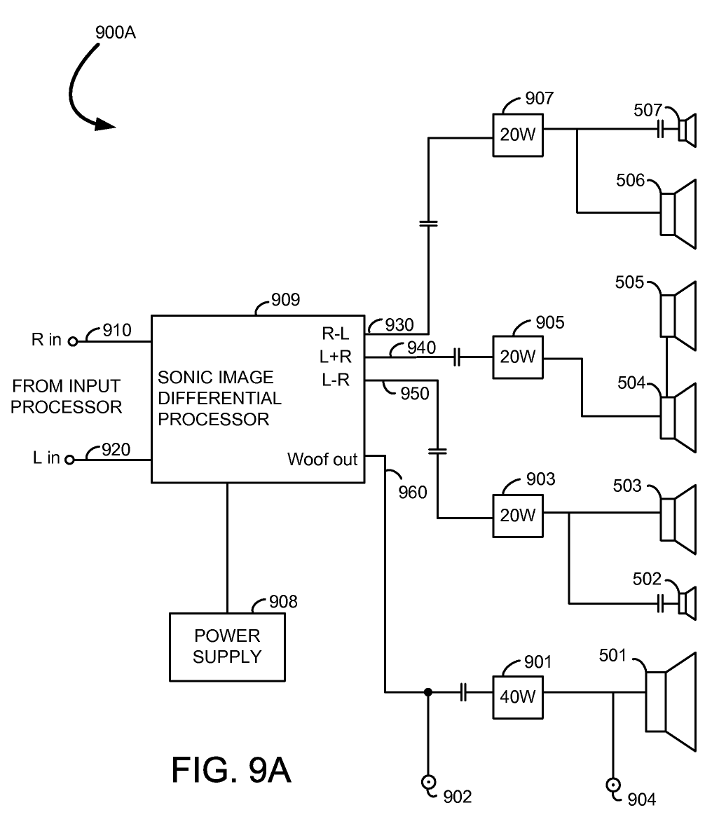

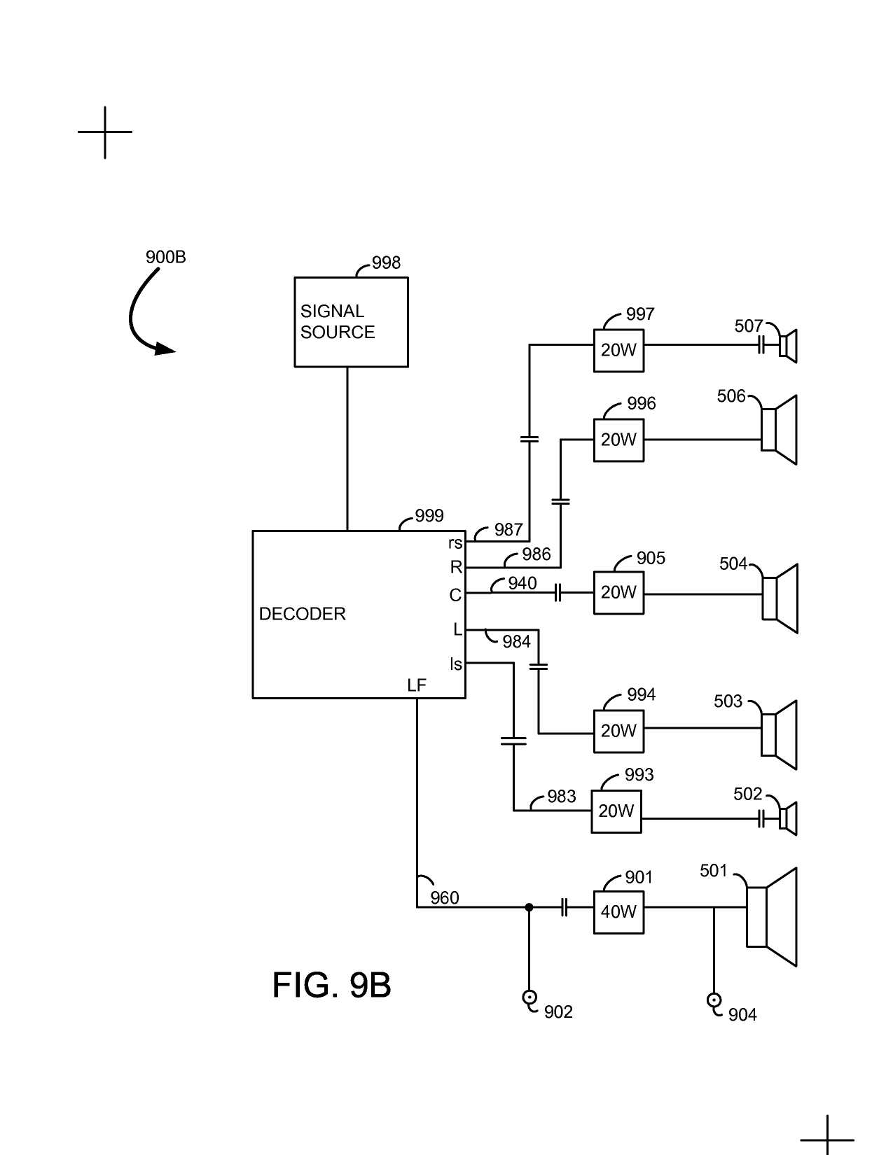

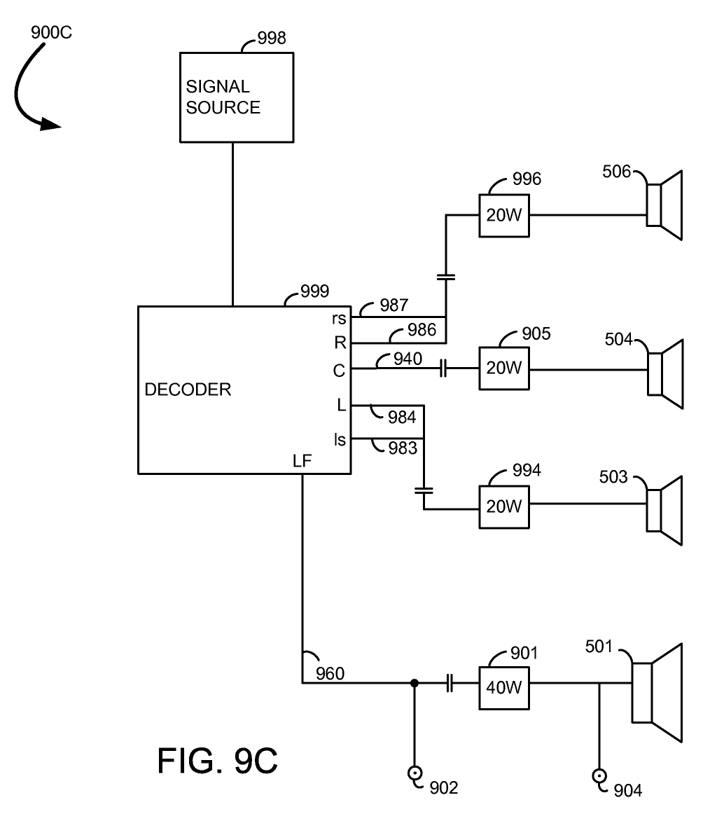

FIG. 9A shows a block diagram of a top plan view of the major components of Bar Point Source Speaker System 500 are shown generally at 900A. These components include a Sonic Image Differential Processor 909, Power Supply 908, three 20 watt amplifiers: Left Amplifier 903, Center Amplifier 905, and Right Amplifier 907 and a 40 watt subwoofer amplifier Woofer Amplifier 901. In some embodiments, amplifiers may have different wattage values as is desired.

Additionally, the speaker array including the Internal Woofer 501, Left Tweeter 502, Left Main Speaker 503, First Center Speaker 504, Second Center Speaker 505, Right Main Speaker 506 and Right Tweeter 507 is shown. Some Sonic Image Differential Processor 909 receives R Input 910 and L Input 920 from the input processor. One embodiment of the structure and function of input processor is discussed above with respect to FIG. 2.

In some embodiments, Sonic Image Differential Processor 909 has two inputs R Input 910 and L Input 920 from input processor, and four outputs R−L Output 930, R+L Output 940, L−R Output 950 and Woofer Output 960 to amplifiers. R−L Output 930 outputs to Right Amplifier 907. Right Amplifier 907 outputs signal to Right Tweeter 507 and Right Main Speaker 506 in parallel. In some embodiments, individual amplifiers may be utilized by each speaker, however the illustrated embodiment minimizes required amplifier components while still maintaining sound integrity. R+L Output 940 outputs to Center Amplifier 905. Center Amplifier 905 output signal drives the First Center Speaker 504. The Second Center Speaker 505 may be serially coupled to the First Center Speaker 504. L−R Output 950 outputs to the Left Amplifier 903. The Left Amplifier 903 output signal drives Left Main Speaker 503 and Left Tweeter 502 in parallel. Woofer Output 960 outputs to Woofer Amplifier 901 and Active External Subwoofer Jack 902. An external subwoofer that has its own power supply may couple with the Active External Subwoofer Jack 902. Woofer Amplifier 901 output signal drives Internal Woofer 501 and External Passive Subwoofer Jack 904. An external subwoofer that does not have its own power supply may couple with the External Passive Subwoofer Jack 904. Power is provided by Power Supply 908.

In operation, Sonic Image Differential Processor 909 processes the R Input 910 and L Input 920 within the interferometric frequency range in accordance with the interferometric properties of the some embodiments. In particular, R Input 910 and L Input 920 are processed into three channels, one for each of the three axis of the Bar Point Source Speaker System 500, and output to amplifiers via outputs as L−R, R+L and R−L. The L−R, R+L and R−L signals are then amplified by Left Amplifier 903, Center Amplifier 905, and Right Amplifier 907 and input to the Left Tweeter 502, Left Main Speaker 503, First Center Speaker 504, Second Center Speaker 505, Right Main Speaker 506 and Right Tweeter 507, respectively, in the Bar Point Source Speaker System 500. R Input 910 and L Input 920 below the interferometric range are output from Sonic Image Differential Processor 909 via line feed (Woof out), then amplified by Woofer Amplifier 901 and input to Internal Woofer 501. In some embodiments, the output of the Woofer Amplifier 901 may be routed externally in order to drive an external subwoofer from External Passive Subwoofer Jack 904 and Active External Subwoofer Jack 902.

In some embodiments, coupling capacitors may be located between the Sonic Image Differential Processor 909 and amplifiers. Additional capacitors may be located between the tweeters and their respective amplifiers.

In some embodiments, the ratios between L—R, R+L and R—L speaker inputs may be additionally adjusted as to provide additional control of speaker outputs.

As stated earlier, the function of the input processor is to re-process the signals from a given acoustic source (such as a DVD, VCR or CD) for input to Sonic Image Differential Processor 909. The input processor structure may take many forms.

FIG. 9B shows an alternate second block diagram of a top plan view of the major components of Bar Point Source Speaker System 500 are shown generally at 900B. These components include a Decoder 999, five 20 watt amplifiers: Left Tweeter Amplifier 993, Left Main Amplifier 994, Center Amplifier 905, Right Main Amplifier 996, and Right Tweeter Amplifier 997 and a 40 watt subwoofer amplifier Woofer Amplifier 901. In some embodiments, amplifiers may have different wattage values as is desired. A Signal Source 998 provides signal to the decoder. Signal Source 998 may include a television, DVD or similar device. Such a system as shown at 900B may utilize AC3 such as Dolby Prologic®, Dolby Digital®, and DTS® digital 5.1 channels with built in Dolby/DTS decoders.

Additionally, a speaker array including the Internal Woofer 501, Left Tweeter 502, Left Main Speaker 503, First Center Speaker 504, Right Main Speaker 506 and Right Tweeter 507 is shown.

In some embodiments, the Decoder 999 outputs an Is Signal 983, an L Signal 984, a C Signal 940, a R Signal 986, and an rs Signal 987, and Woofer Output 960 to amplifiers. The Is Signal 983 outputs to Left Tweeter Amplifier 993. Left Tweeter Amplifier 993 output signal drives Left Tweeter 502. The L Signal 984 outputs to Left Main Amplifier 994. Left Main Amplifier 994 output signal drives Left Main Speaker 503. C Output 940 outputs to Center Amplifier 905. Center Amplifier 905 output signal drives the First Center Speaker 504. The rs Signal 987 outputs to Right Tweeter Amplifier 997. Right Tweeter Amplifier 997 output signal drives Right Tweeter 507. The R Signal 986 outputs to Right Main Amplifier 996. Right Main Amplifier 996 output signal drives Right Main Speaker 506. Woofer Output 960 outputs to Woofer Amplifier 901 and Active External Subwoofer Jack 902. An external subwoofer that has its own power supply may couple with the Active External Subwoofer Jack 902. Woofer Amplifier 901 output signal drives Internal Woofer 501 and External Passive Subwoofer Jack 904. An external subwoofer that does not have its own power supply may couple with the External Passive Subwoofer Jack 904.

In some embodiments, the ratios between outputs Is Signal 983, L Signal 984, C Signal 940, R Signal 986, and rs Signal 987 may be adjusted as to provide additional control of speaker outputs.

FIG. 9C shows an alternate third block diagram of a top plan view of the major components of Bar Point Source Speaker System 500 are shown generally at 900C. These components include a Decoder 999, three 20 watt amplifiers: Left Main Amplifier 994, Center Amplifier 905, and Right Main Amplifier 996 and a 40 watt subwoofer amplifier Woofer Amplifier 901. In some embodiments, amplifiers may have different wattage values as is desired. A Signal Source 998 provides signal to the decoder. Signal Source 998 may include a television, DVD or similar device. Such a system as shown at 900C may utilize AC3 such as Dolby Prologic®, Dolby Digital®, and DTS® digital 5.1 channels with built in Dolby/DTS decoders.

Additionally, a speaker array including the Internal Woofer 501, Left Main Speaker 503, First Center Speaker 504, and Right Main Speaker 506 is shown.

In some embodiments, the Decoder 999 outputs an ls Signal 983, an L Signal 984, a C Signal 940, a R Signal 986, and an rs Signal 987, and Woofer Output 960 to amplifiers. The ls Signal 983 may join the L Signal 984 to form an L+ls signal. The L+ls signal outputs to Left Main Amplifier 994. Left Main Amplifier 994 output signal drives Left Main Speaker 503. C Output 940 outputs to Center Amplifier 905. Center Amplifier 905 output signal drives the First Center Speaker 504. The rs Signal 987 may join the R Signal 986 to form an R+rs signal. The R+rs signal outputs to Right Main Amplifier 996. Right Main Amplifier 996 output signal drives Right Main Speaker 506. Woofer Output 960 outputs to Woofer Amplifier 901 and Active External Subwoofer Jack 902. An external subwoofer that has its own power supply may couple with the Active External Subwoofer Jack 902. Woofer Amplifier 901 output signal drives Internal Woofer 501 and External Passive Subwoofer Jack 904. An external subwoofer that does not have its own power supply may couple with the External Passive Subwoofer Jack 904.

In some embodiments, the ratios between outputs ls Signal 983, L Signal 984, C Signal 940, R Signal 986, and rs Signal 987 may be adjusted as to provide additional control of speaker outputs.

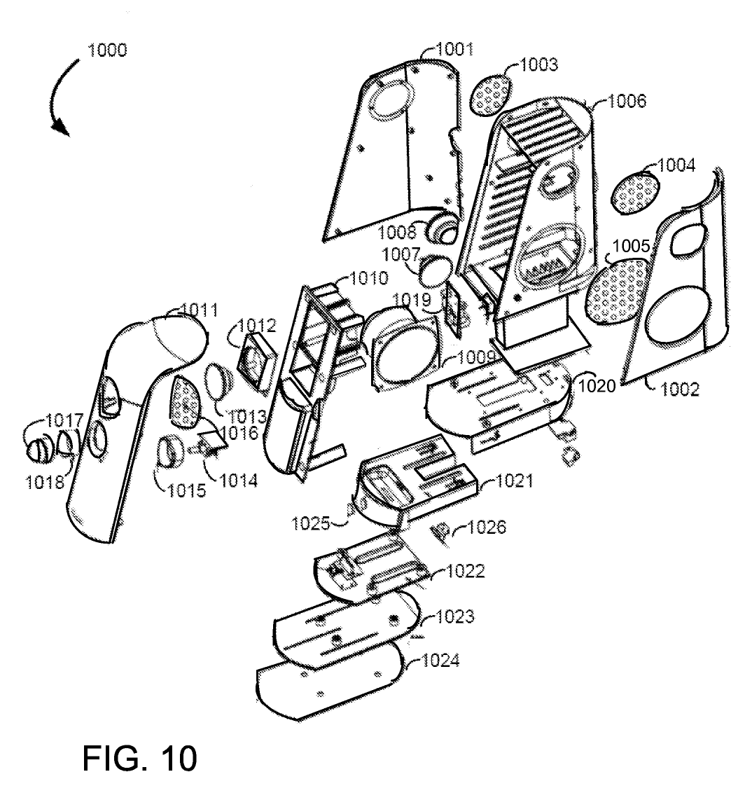

FIG. 10 shows an exploded diagram of a Docking Point Source Speaker System 1000 in accordance with an embodiment of the present invention. The Docking Point Source Speaker System 1000 includes a Left Housing 1001, Right Housing 1002 and Forward Housing 1011 which form the bulk of the external housing of the Docking Point Source Speaker System 1000.

Internal Mount 1006 provides structural support for Docking Point Source Speaker System 1000 and mounts Right Speaker 1007, Left Speaker 1008, and Subwoofer 1009 in place. Left Housing 1001, Right Housing 1002, Forward Housing 1011 and Internal Mount 1006 may be plastic, metal or any additional suitable material. Internal Mount 1006 may be a rigid material with adequate mechanical properties due to the nature of the speakers to repel one another.

Forward Mount 1010 may provide mounting for Center Speaker Mount 1012. Center Speaker Mount 1012 then mounts Center Speaker 1013. In some embodiments, Forward Mount 1010 and Center Speaker Mount 1012 may be integrated into Internal Mount 1006. In the present illustration Internal Mount 1006, Forward Mount 1010 and Center Speaker Mount 1012 are shown separate due to manufacturing ease. Like Internal Mount 1006, Forward Mount 1010 and Center Speaker Mount 1012 may be a rigid material, such as metal or plastic, with adequate mechanical properties due to the nature of the speakers to repel one another.

Left Speaker Cover 1003, Right Speaker Cover 1004, Subwoofer Cover 1005 and Center Speaker Cover 1016 cover Left Speaker 1008, Right Speaker 1007, Subwoofer 1009 and Center Speaker 1013 respectively. Left Speaker Cover 1003, Right Speaker Cover 1004, Subwoofer Cover 1005 and Center Speaker Cover 1016 provide protection and aesthetic qualities to the Docking Point Source Speaker System 1000. Left Speaker Cover 1003, Right Speaker Cover 1004, Subwoofer Cover 1005 and Center Speaker Cover 1016 may be metal mesh, fabric or any suitable material that permits sound propagation.

Sensor 1014, Internal Gasket 1015, External Gasket 1017 and Control Knob 1018 provide volume and additional control functions for the Docking Point Source Speaker System 1000. Sensor 1014 couples to Processor 1019. Processor 1019 also provides processing of inputs from the Docking Tray Bottom 1022 in order to generate output signals for the speakers. A power supply and amplifiers may be housed in the Internal Mount 1006 to provide signals for the speakers. However, in some embodiments the power supply and/or amplifiers may be external to the Docking Point Source Speaker System 1000 in order to facilitate a compact design. The processing of such embodiments of the present invention may mirror those disclosed in FIGS. 1 to 4.

Docking Tray Housing 1021, Docking Tray Bottom 1022 and Processor Coupler 1026 form a tray capable of sliding in and out from an enclosure formed by Enclosure Top 1020 and Enclosure Bottom 1023. Docking Tray Bottom 1022 includes terminals for the docking of an mp3 player, or any additional digital music player, such as an iPod®. This input is sent via Processor Coupler 1026 to Processor 1019 for processing.

The tray and enclosure couple to Internal Mount 1006 which may include a motor for providing extension and retraction of the tray. Thus the tray formed by Docking Tray Housing 1021 and Docking Tray Bottom 1022 may slide out of the enclosing for convenient music player docking, and may be retracted into the housing when not in use, thereby maintaining a sleek shape and attractive appearance.

A Footing 1024 couples to Enclosure Bottom 1023 to provide traction for the Docking Point Source Speaker System 1000 on smooth surfaces, and to prevent scratching by the Docking Point Source Speaker System 1000 to the surface it is upon. Indicator Light 1025 provides indication of power, docking or additional indications.

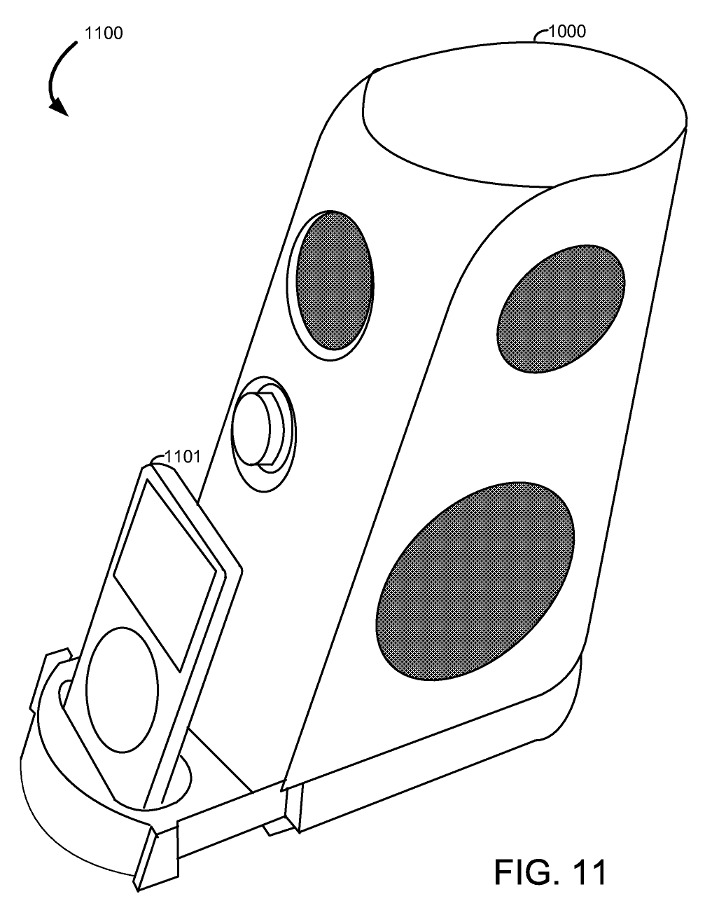

FIG. 11 shows an assembled schematic diagram of the Docking Point Source Speaker System 1000, shown generally at 1100. Here Docking Point Source Speaker System 1000 may be seen assembled with the tray extended. A Music Player 1101 is shown docked in the tray of Docking Point Source Speaker System 1000. Removal of the Music Player 1101 may result in the retraction of the tray. Additionally, the stylistic design of the Docking Point Source Speaker System 1000 may be clearly seen.

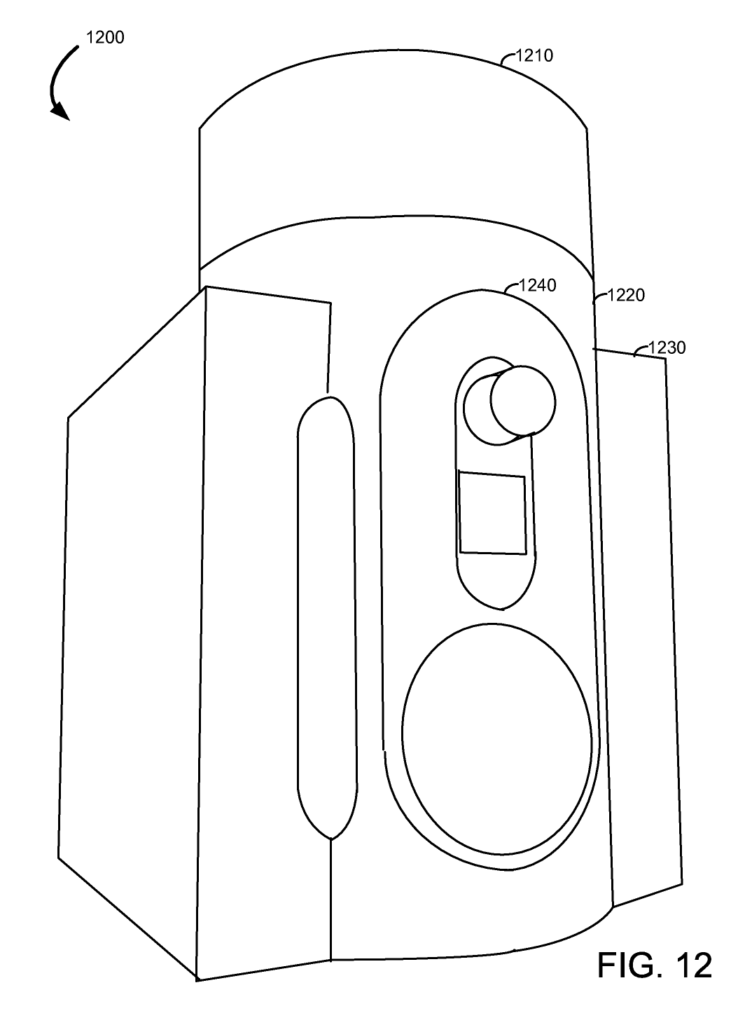

FIG. 12 shows an illustration of a Tower Point Source Speaker System 1200 in accordance with an embodiment of the present invention. A Speaker Tower 1210 is located in the top of the Tower Point Source Speaker System 1200. Speaker Tower 1210 is coupled to a Front Panel 1220, which has Control Panel 1240 and a woofer port. Front Panel 1220 may be plastic, metal or any suitable material. Front Panel 1220 couples to a Woofer Box 1230. Woofer Box 1230 may be wood or any material suitable for a woofer acoustic chamber.

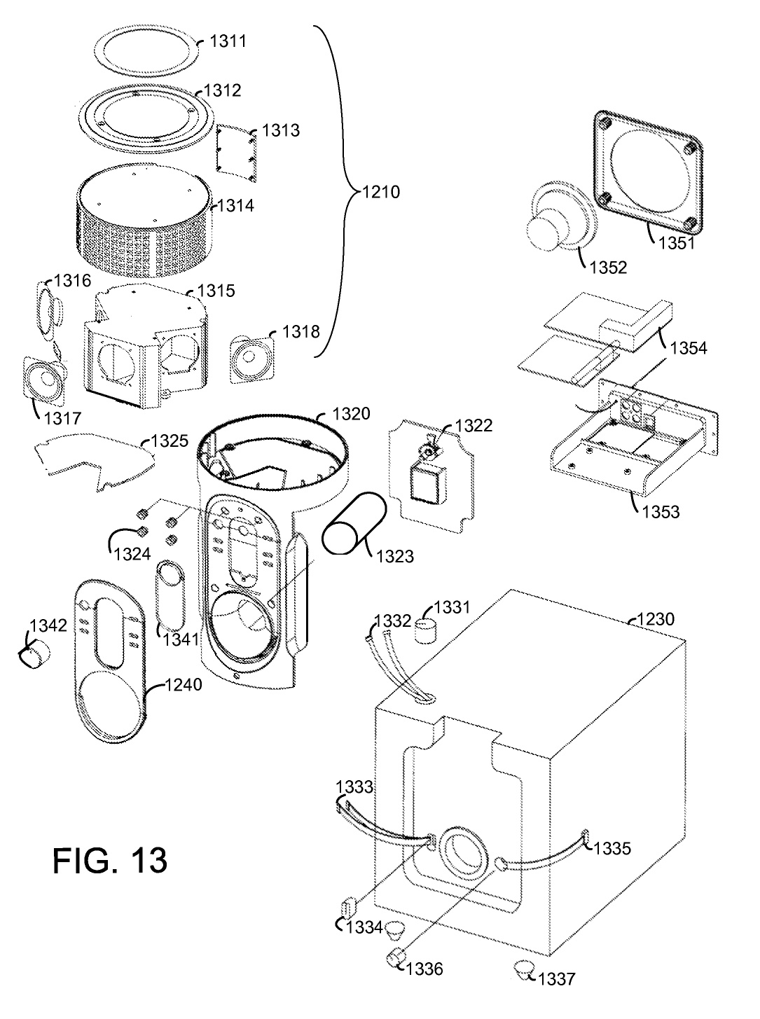

FIG. 13 shows an exploded diagram of the Tower Point Source Speaker System 1200 of FIG. 12. The Speaker Tower 1210 may be seen as composed of Cover Top 1311 coupled to Deco Cover 1312. Cover Top 1311 and Deco Cover 1312 may, in some embodiments, be a singular piece. Deco Cover 1312 couples to Speaker Net 1314. Access Panel 1313 may exist on the rear face of Speaker Net 1314 to facilitate access to the rear of the tower. Speaker Net 1314 may be metal mesh, fabric or any suitable material that permits sound propagation. Speaker Net 1314 functions as a protective barrier for the speakers, as well as having aesthetic functions. Within Speaker Net 1314 exists Speaker Mount 1315. Right Speaker 1316, Center Speaker 1317, and Left Speaker 1318 mount upon Speaker Mount 1315. Speaker Mount 1315 may be a rigid material, such as metal or plastic, with adequate mechanical properties due to the nature of the speakers to repel one another.

Speaker Cushion 1325 couples to both Front Panel 1220 and Speaker Mount 1315. Speaker Cushion 1325 may provide cushioning between the speakers and the base, thereby preventing interfering wave propagation. Speaker Cushion 1325 may be a rubber, cork, foam or other suitable material.

Sensor Panel 1322 couples to the rear face of Front Panel 1220. Sensor Panel 1322 includes a sensor that responds to user adjustment of the Control Panel 1240 and Control Knob 1342. Additionally, Sensor Panel 1322 may include processors. Deco Front 1341, as shown, provides enhanced aesthetics. Couplers 1324 couple Front Panel 1220 and Control Panel 1240 together. Control Panel 1240 may include controls and, in some embodiments, a screen or other interface. Port Tube 1323 provides porting from the interior of Woofer Box 1230 to the exterior through Front Panel 1220.

Front Panel 1220 and Control Panel 1240 may be virtually any material. In some embodiments, plastics may be utilized due to low cost and ease of manufacturing. Port Tube 1323 may be a paper cylinder or other acoustically desirable material.

Woofer Box 1230 provides a base for the Tower Point Source Speaker System 1200 as well as an acoustic woofer chamber. Woofer Box 1230 may, in some embodiments, be wood or other acoustically desirable material. Footings 1337 may be coupled to the bottom of Woofer Box 1230 to prevent slippage of the Tower Point Source Speaker System 1200 and protect surfaces from scratching. Control Connector 1333 and Tuner Connector 1335 extend from the Rear Terminal 1353, mounted in the rear of the Woofer Box 1230, through the Woofer Box 1230 cavity and extend from the forward face of the Woofer Box 1230 to couple to Control Panel 1240 and Sensor Panel 1322. Control Connector Cushion 1334 and Tuner Connector Cushion 1336 may protect Control Connector 1333 and Tuner Connector 1335, respectively, from damage at the entrance to Woofer Box 1230.

Likewise, in some embodiments, Speaker connectors 1332 travels from Rear Terminal 1353 to the Right Speaker 1316, Center Speaker 1317 and Left Speaker 1318 through the Woofer Box 1230. Speaker Connector Cushion 1331 provides protection to Speaker connectors 1332 from damage at the entrance to Woofer Box 1230.

Rear Terminal 1353 provides terminals for input jacks, and for Amplifier 1354. Amplifier 1354 provides, via Rear Terminal 1353, output to the speakers. Rear Terminal 1353 may include processors similar to those shown in FIGS. 1 to 3. In some embodiments, Rear Terminal 1353 includes a tuner for receiving radio signals. Woofer 1352 mounts on Woofer Mounting Bracket 1351, which may couple to the rear of the Woofer Box 1230.

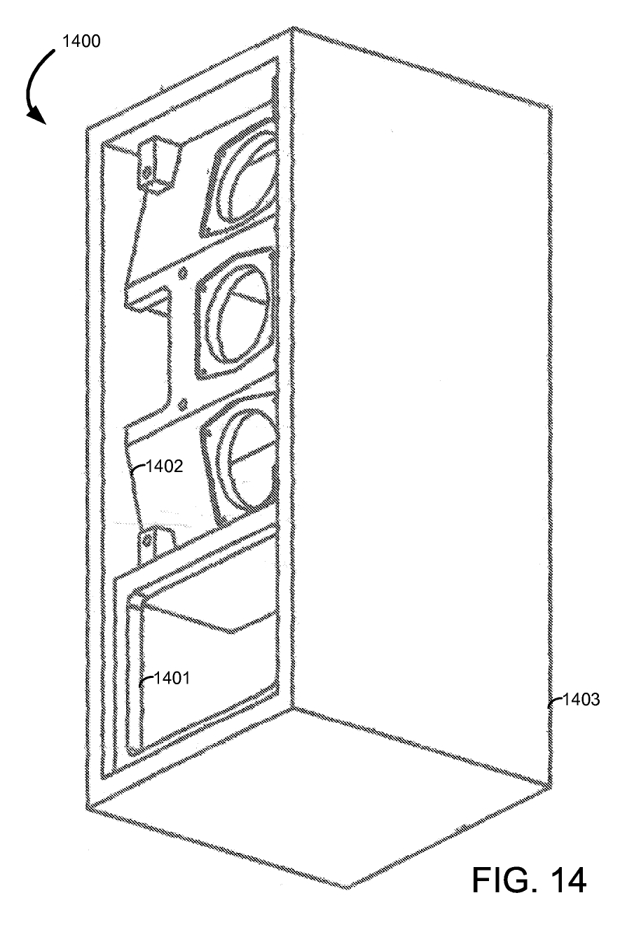

FIG. 14 shows an illustration of a Short Bar Point Source Speaker System 1400 in accordance with an embodiment of the present invention. Similar to the Bar Point Source Speaker System 500, the Short Bar Point Source Speaker System 1400 utilizes substantially forward facing speakers. However, where the embodiments illustrated in Bar Point Source Speaker System 500 included 6 forward speakers and emphasized a sleek profile, the embodiments found in Short Bar Point Source Speaker System 1400 utilize larger speakers, a vertical woofer, larger height and shorter length. The Speaker System Case 1403 may be wood or other acoustically similar material. A tri-panel Speaker Mount 1402 may be a rigid material, such as metal or plastic, with adequate mechanical properties due to the nature of the speakers to repel one another. Control Panel 1401 provides area for user controls.

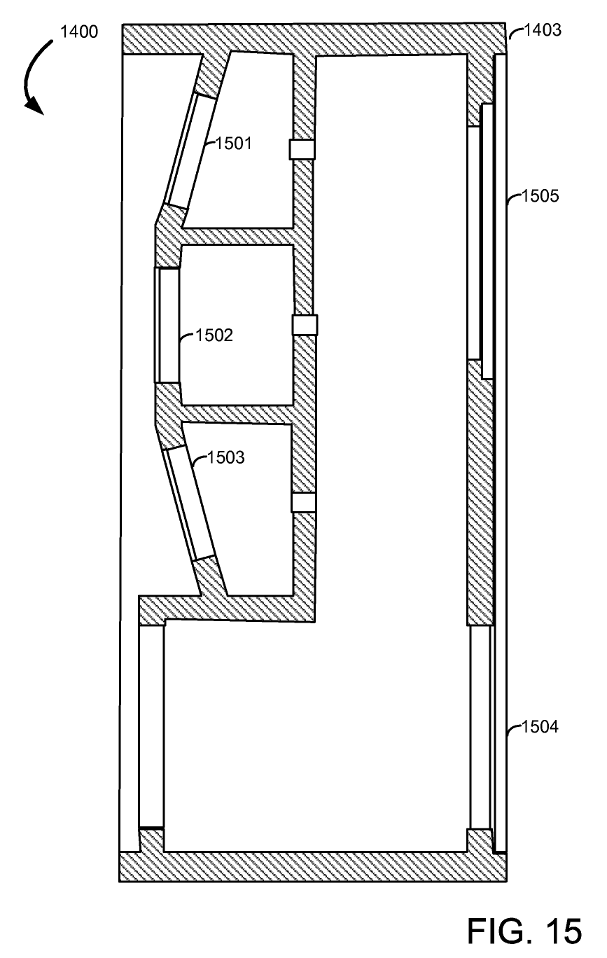

FIG. 15 shows a top cross sectional diagram of the Short Bar Point Source Speaker System 1400. Speaker System Case 1403 geometry is more easily seen in this illustration. Right Speaker 1501, Center Speaker 1502 and Left Speaker 1503 may be seen mounted on the Speaker Mount 1402. Additionally, Woofer 1504 may be vertically mounted on the rear face of the Speaker System Case 1403. Terminal Panel 1505 may also be mounted upon the rear face of the Speaker System Case 1403. Terminal Panel 1505 may include jacks, processors and amplifiers.

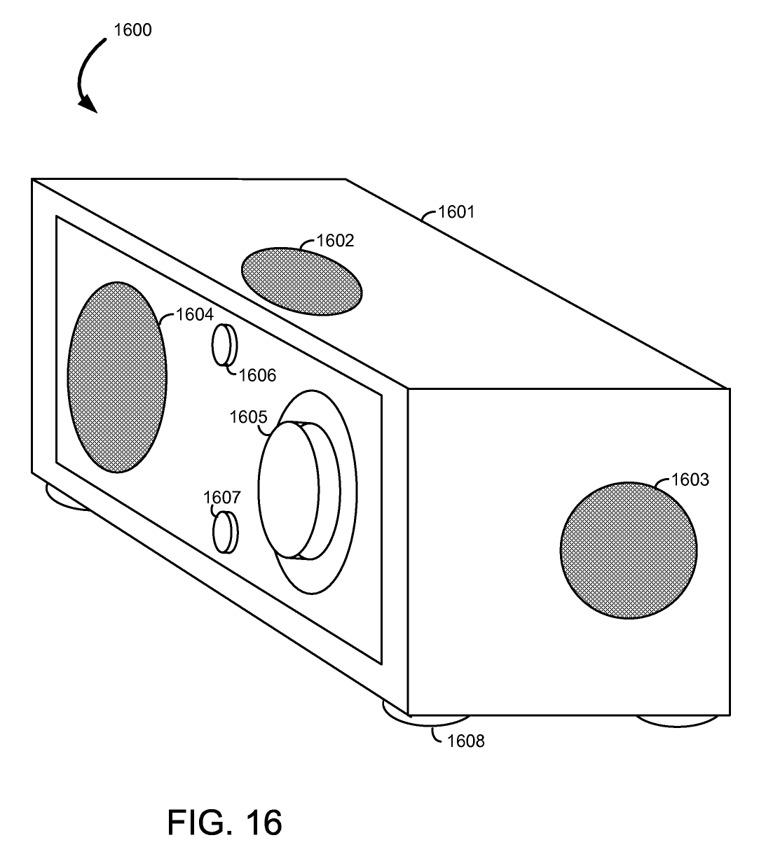

FIG. 16 shows an illustration of a Radio Point Source Speaker System 1600 in accordance with an embodiment of the present invention. A Housing 1601 may encompass the Radio Point Source Speaker System 1600. The housing may include a Right Speaker 1603, Center Speaker 1602 and a left speaker (not visible in the illustration). Speakers may, in some embodiments, be covered by a metal mesh, cloth or other protective material.

In some embodiments, the Center Speaker 1602 may be substantially upward facing. A Woofer 1604 may additionally be mounted on the Housing 1601. The present speaker orientation enables compact sizing of the Radio Point Source Speaker System 1600, thereby providing “tabletop” usage ability. Other speaker orientations may be utilized as needed however.

The Radio Point Source Speaker System 1600 includes a tuner within the Housing 1601. The tuner may be controlled by the Tuning Dial 1605. Volume Dial 1606 may provide volume control. An additional Control Dial 1607 may be utilized to perform additional functions, such as switching from AM to FM radio frequency bands. Of Course additional alternate control interfaces may be utilized for the Radio Point Source Speaker System 1600 as is functionally or aesthetically desired.

The Radio Point Source Speaker System 1600 may include an internal power source and amplifiers, however, in some embodiments the power supply may be external as to facilitate the compact design of Radio Point Source Speaker System 1600.

In sum, the invention disclosed herein provides a novel and advantageous point source speaker system. Although bar, cubical and docking geometries are discussed, additional geometries, speaker arrangements, speaker types and numbers are possible while remaining within the spirit of the disclosed invention. For instance additional speakers may be incorporated within the bar style point source speaker system as to improve user preferences.

Although the present invention has been described in considerable detail with reference to exemplary embodiments, modifications, variations, permutations, and substitute equivalents may be made to the disclosed embodiments while remaining within the subject and spirit of the invention. Therefore, the spirit and scope of the appended claims should not be limited to the description of the versions contained herein.

What is claimed is:

1. A point source speaker system, useful in association with an audio device, the point source speaker system comprising:
an enclosure configured to mount a speaker array, wherein the speaker array includes a substantially forward-facing left speaker, a substantially forward-facing center speaker, a substantially forward-facing right speaker, and a horizontally mounted woofer speaker; and
wherein the enclosure includes:
a woofer tunnel configured to accelerate woofer sound waves generated by the woofer speaker, wherein the woofer tunnel is located behind the substantially forward-facing left speaker, the substantially forward-facing center speaker and the substantially forward-facing right speaker; and
a woofer baffle configured to couple the woofer tunnel to a woofer port.

2. The point source speaker system of claim 1, wherein the woofer baffle is a conical volume.

3. The point source speaker system of claim 1, wherein the woofer port is coupled to a forward-facing surface of the enclosure.

4. The point source speaker system of claim 1, wherein the woofer port is coupled to a side-facing surface of the enclosure.

5. The point source speaker system of claim 1, wherein the woofer port is coupled to a top-facing surface of the enclosure.

6. The point source speaker system of claim 1, wherein the woofer port is coupled to a downward-facing surface of the enclosure.

7. The point source speaker system of claim 1, wherein the woofer tunnel has a substantially square cross-sectional profile.

8. The point source speaker system of claim 1, wherein the woofer tunnel has a substantially rectangular cross-sectional profile.

9. The point source speaker system of claim 1, wherein the woofer tunnel has a substantially cylindrical profile.

10. The point source speaker system of claim 1, further comprising a substantially forward-facing left tweeter.

11. The point source speaker system of claim 1, further comprising a substantially forward-facing second center speaker.

12. The point source speaker system of claim 1, further comprising a substantially forward-facing right tweeter.

13. The point source speaker system of claim 10, wherein the left speaker and the left tweeter both receive a left signal in parallel from the audio device.

14. The point source speaker system of claim 11, wherein the center speaker and the second center speaker both receive a center signal in series from the audio device.

15. The point source speaker system of claim 12, wherein the right speaker and the right tweeter both receive a right signal in parallel from the audio device.
